(19) United States
(12) Patent Application Publication
(10) Pub. No.: US 2022/0073098 A1
(43) Pub. Date: Mar. 10, 2022

(54) METHOD AND APPARATUS FOR PREDICTING LATERAL ACCELERATION PRIOR TO AN AUTOMATED LANE CHANGE

(71) Applicant: GM GLOBAL TECHNOLOGY OPERATIONS LLC, Detroit, MI (US)

(72) Inventors: Aldo P. D'Orazio, Howell, MI (US); Crystal Nassouri, West Bloofield, MI (US); Braden J. Swantick, Canton, MI (US)

(73) Assignee: GM GLOBAL TECHNOLOGY OPERATIONS LLC, Detroit, MI (US)

(21) Appl. No.: 17/015,363

(22) Filed: Sep. 9, 2020

(51) Int. Cl. B60W 60/00; B60W 30/18; G01S 19/42; B60W 40/109; G01C 21/34; B60W 50/14; B60W 40/072; G01C 21/00; B60W 50/08

(52) U.S. Cl. CPC B60W 60/0011; B60W 30/18163; G01S 19/42; B60W 40/109; G01C 21/3407; B60W 2050/146; B60W 40/072; G01C 21/3863; B60W 50/087; B60W 2552/00; B60W 50/14

(57) ABSTRACT

The present application relates to a method and apparatus for controlling an ADAS equipped vehicle including an input for receiving a lane change request, a global positioning sensor for detecting a vehicle location, a memory for storing a map data, a vehicle controller for performing a lane change in response to a lane change navigational route, and a processor configured for generating the lane change navigational route in response to the map data and the lane change request, for calculating a predicted lateral acceleration within the lane change navigational route in response to the map data and the lane change request and for coupling the lane change navigational route to the vehicle controller in response to the predicted lateral acceleration being less than a lateral acceleration threshold.

### BACKGROUND

The present disclosure relates generally to programming motor vehicle control systems. More specifically, aspects of this disclosure relate to systems, methods and devices to determine the safety and viability of an automated lane change feature by performing a comparison of predicted lateral acceleration based on road geometry in the target lane with estimated time to complete the lane change in an ADAS equipped vehicle.

The operation of modern vehicles is becoming more automated, i.e. able to provide driving control with less and less driver intervention. Vehicle automation has been categorized into numerical levels ranging from zero, corresponding to no automation with full human control, to five, corresponding to full automation with no human control. Various advanced driver-assistance systems (ADAS), such as cruise control, adaptive cruise control, and parking assistance systems correspond to lower automation levels, while true “driverless” vehicles correspond to higher automation levels.

Adaptive cruise control systems have been developed where not only does the system maintain the set speed, but also will automatically slow the vehicle down in the event that a slower moving preceding vehicle is detected using various sensors, such as radar and cameras. Further, some vehicle systems attempt to maintain the vehicle near the center of a lane on the road. However, maintaining a lane speed that is too fast on a road curve could cause not only discomfort for vehicle occupants, but also, under some circumstances, the loss of vehicle control.

For a human driver approaching a curve at too high of a speed, vehicle control prior to normal curve steering begins with a reduction in vehicle speed. The deceleration level required for a curve depends on many factors, such as the curvature of the road, the vehicle speed, the curve bank angle, the road gradient, the road surface coefficient of friction, vehicle characteristics, driver competence, etc. Usually, a driver relies on his or her visual information about the upcoming curve to determine the proper speed and braking level.

The conventional implementations of the active safety approaches have been anti-lock braking and traction control systems to help drivers corner safely by sensing road conditions and intervening in the vehicle brake and throttle control selections. However, automated driving systems may be helped further by complimenting such control systems with strategies that intervene in vehicle control prior to entering a curve. It would be desirable to these problems to provide a method and apparatus for lane change on demand operation in an ADAS equipped motor vehicle.

The above information disclosed in this background section is only for enhancement of understanding of the background of the invention and therefore it may contain information that does not form the prior art that is already known in this country to a person of ordinary skill in the art.

### SUMMARY

Disclosed herein are autonomous vehicle control system training systems and related control logic for provisioning autonomous vehicle control, methods for making and methods for operating such systems, and motor vehicles equipped with onboard control systems. By way of example, and not limitation, there is presented an automobile with onboard vehicle control learning and control systems.

In accordance with an aspect of the present invention, a vehicle is provided that includes an input device for receiving a lane change request, a global positioning sensor for detecting a vehicle location, a memory for storing a map data, a vehicle controller for performing a lane change in response to a lane change navigational route, and a processor configured for generating the lane change navigational route in response to the map data and the lane change request, for calculating a predicted lateral acceleration within the lane change navigational route in response to the map data and the lane change request and for coupling the lane change navigational route to the vehicle controller in response to the predicted lateral acceleration being less than a lateral acceleration threshold.

In accordance with another aspect of the present invention the processor is further operative to deny the lane change request and to generate an operator notification in response to the predicted lateral acceleration exceeding the lateral acceleration threshold.

In accordance with another aspect of the present invention the predicted lateral acceleration is calculated in response to a curve within the lane change navigational route.

In accordance with another aspect of the present invention the processor is further operative to detect a roadway curve in response to the lane change navigation route and to calculate a plurality of predicted lateral accelerations at a plurality of points within the curve.

In accordance with another aspect of the present invention the processor is further operative to delay the lane change request in response to the predicted lateral acceleration exceeding the lateral acceleration threshold and to recalculate the predicted lateral acceleration at a point beyond the lane change navigational route.

In accordance with another aspect of the present invention the processor is operative to generate an alternate lane change navigational route at a reduced vehicle speed in response to the predicted lateral acceleration exceeding the lateral acceleration threshold.

In accordance with another aspect of the present invention the processor is further operative to generate a throttle control signal indicative of a reduced vehicle speed to couple to the vehicle controller in response to the predicted lateral acceleration exceeding the lateral acceleration threshold.

In accordance with another aspect of the present invention the lane change request is generated in response to a user input.

In accordance with another aspect of the present invention, a method performed by a processor is provided that includes performing an advanced driving assistance algorithm, receiving a request for a lane change, generating a lane change navigational route in response to the request for a lane change, a vehicle location and a map data, calculating a predicted lateral acceleration in response to the navigational route, and executing a lane change in response to the lane change navigational route in response to the predicted lateral acceleration being less than a lateral acceleration threshold.

In accordance with another aspect of the present invention the method includes generating an indication of a denial of the request for a lane change in response to the predicted lateral acceleration exceeding the lateral acceleration threshold.

In accordance with another aspect of the present invention the predicted lateral acceleration is calculated in response to a curve within the lane change navigational route.

In accordance with another aspect of the present invention the method includes detecting a curve in a roadway in response to the lane change navigational route and wherein the predicted lateral acceleration is calculated for a plurality of points within the curve in the roadway.

In accordance with another aspect of the present invention the method includes delaying the execution of the lane change in response to the predicted lateral acceleration exceeding the lateral acceleration threshold.

In accordance with another aspect of the present invention the method includes generating an alternate lane change navigational route at a reduced vehicle speed in response to the predicted lateral acceleration exceeding the lateral acceleration threshold.

In accordance with another aspect of the present invention the method includes reducing a vehicle speed in response to the predicted lateral acceleration exceeding the lateral acceleration threshold.

In accordance with another aspect of the present invention the current lane score and the adjacent lane score are generated in response to a lane change request received via an ADAS algorithm.

In accordance with another aspect of the present invention the request for a lane change is received via an input device.

In accordance with another aspect of the present invention the request for a lane change is received via an advanced driving assistance system controller.

In accordance with another aspect of the present invention, an advanced driver assistance system for controlling a vehicle includes an input device for receiving a request for a lane change, a processor operative to generate a lane change navigational route in response to a map data, a current vehicle location, and the request for the lane change, the processor being further operative to determine a predicted lateral acceleration at a point along the lane change navigational route, the processor being further operative to generate a warning signal in response to the predicted lateral acceleration exceeding a lateral acceleration threshold, and a display for displaying a denial of lane change to a vehicle operator in response to the warning signal.

In accordance with another aspect of the present invention the advanced driver assistance system includes a vehicle controller for controlling a vehicle along the lane change navigational route in response to the lateral acceleration threshold exceeding the predicted lateral acceleration.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings.

FIG. 1 shows an operating environment for predictive lateral acceleration for a lane change on demand operation in an ADAS equipped motor vehicle according to an exemplary embodiment.

FIG. 2 shows a block diagram illustrating a system for predictive lateral acceleration for a lane change on demand operation in an ADAS equipped motor vehicle according to an exemplary embodiment.

FIG. 3 shows a flow chart illustrating a method for predictive lateral acceleration for a lane change on demand operation in an ADAS equipped motor vehicle according to another exemplary embodiment.

FIG. 4 shows a block diagram illustrating a system for predictive lateral acceleration for a lane change on demand operation in an ADAS equipped motor vehicle according to another exemplary embodiment.

FIG. 5 shows a flow chart illustrating a method for predictive lateral acceleration for a lane change on demand operation in an ADAS equipped motor vehicle according to another exemplary embodiment.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

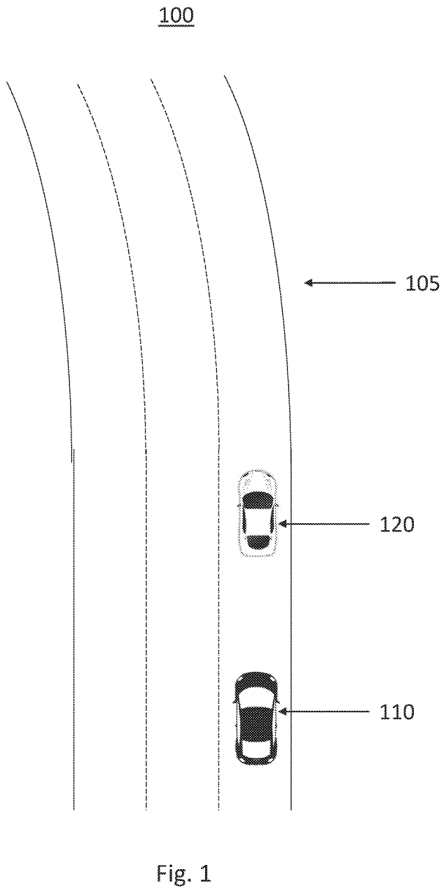

FIG. 1 schematically illustrates an operating environment 100 for predictive lateral acceleration for a lane change on demand operation in an ADAS equipped motor vehicle 110. In this exemplary embodiment of the present disclosure, the host vehicle 110 is driving on a multilane roadway 105 along with a proximate vehicle 120 also navigating the roadway 105.

In this exemplary embodiment, the host vehicle 110 is operative to perform an ADAS operation, such as lane centering control (LCC). During operation of an automated LCC system, a vehicle operator, may be able to request a lane change operation, such as a lane change on demand (LCoD). This exemplary system and method are operative to receive a request for LCoD, such as a right side LCoD, from a vehicle operator or from an ADAS controller. In response to the request, the system is operative to detect an upcoming curve which may be reached during the LCoD operation. The system is then operative to predict a lateral acceleration for the host vehicle 110 in the curve at the speed and direction during the LCoD operation. If the predicted lateral acceleration (PCL) exceeds a threshold lateral acceleration the system will then be operative to deny the LCoD or to delay the LCoD until the host vehicle 110 has navigated past the curve.

The system and method for predictive lateral acceleration for a lane change on demand operation improves the safety of the vehicle operations while performing an ADAS operation. An exemplary system may be operative to use predictive curve speed control to control the speed of the host vehicle while in curves. In addition, the exemplary method and system may use predictive curve speed control to evaluate a host lane, as well as an adjacent lane for upcoming roadway curvatures that will exceed the lateral acceleration limit threshold for LCC and/or other ADAS operations. Further, the system and method may also restrict a LCoD maneuver based on upcoming road curvature and predicted lateral acceleration for the target lane by considering a time to target curve and the speed reduction required to maintain the curve and the lateral acceleration limit boundaries. The exemplary system further increases safety for LCoD and automated lane change operations by determining if the road curvature ahead is gradual enough to allow a safe and comfortable automatic lane change experience for the customer.

In an exemplary application, the host vehicle 110 may be travelling in the rightmost lane of a three-lane roadway 105 and may be approaching a slower preceding vehicle 120. The driver of the host vehicle 110 may actuator a turn signal to initiate a left side LCoD request to a center lane of the roadway 105 in response to the approaching of the slower preceding vehicle. The exemplary system is then operative to detect an upcoming curve in the roadway 105, to calculate a predictive lateral acceleration during the lane change operation within the curve, and to compare the calculated predictive lateral acceleration to a lateral acceleration threshold. Should be predictive lateral acceleration during the planned LCoD operation exceed the lateral acceleration threshold, the exemplary system may then be operative to delay the LCoD operation or to deny the LCoD operation and to provide an appropriate warning notification to a vehicle operator.

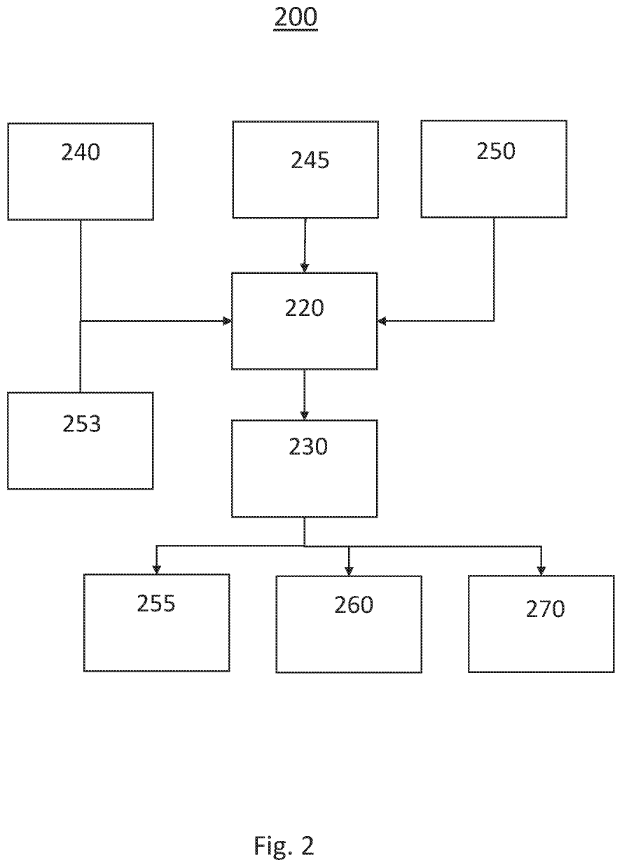

Turning now to FIG. 2, a block diagram illustrating an exemplary implementation of a system 200 for predictive lateral acceleration for a lane change on demand operation in an ADAS equipped motor vehicle is shown. The system 200 includes a processor 220, a camera 240 and a GPS sensor 245. In addition, the processor 220 may receive information such as map data 250 from a memory or the like, and user input via a user interface 253.

The camera 240 may be a low fidelity camera with a forward field of view (FOV). The camera 240 may be mounted inside the vehicle behind the rear view mirror or may be mounted on the front fascia of the vehicle. The camera may be used to detect preceding and proximate vehicles, obstacles, lane markers, road surface edges, and other roadway markings during ADAS operation. In addition, the camera may be used to extract road curvature information via a conditioning buffer to predict the lateral acceleration of the vehicle. Images captured by the camera 240 and data generated from the images may be used to augment map data stored in the memory 250.

The GPS sensor 245 receives a plurality of time stamped satellite signals including the location data of a transmitting satellite. The GPS then uses this information to determine a precise location of the GPS sensor 245. The processor 220 may be operative to receive the location data from the GPS sensor 245 and store this location data to the memory 250. The memory 250 may be operative to store map data for use by the processor 220. The memory 250 may be further operative to store map data wherein the map data may be high definition map data includes detailed representations of roadways including precise roadway locations, lane locations, curves, elevations, and other roadway details.

The processor 220 is operative to engage and control the ADAS in response to an initiation of the ADAS from a user via the user interface 253. In an ADAS operation, the processor 220 may be operative to generate a desired path in response to a user input or the like wherein the desired path may include lane centering, curve following, lane changes, etc. This desired path information may be determined in response to the vehicle speed, the yaw angle and the lateral position of the vehicle within the lane. Once the desired path is determined, a control signal is generated by the processor 220 indicative of the desired path and is coupled to the vehicle controller 230. The vehicle controller 230 is operative to receive the control signal and to generate an individual steering control signal to couple to the steering controller 270, a braking control signal to couple to the brake controller 260 and a throttle control signal to couple to the throttle controller 255 in order to execute the desired path.

According to an exemplary embodiment, the processor 220 is further operative to receive a lane change request from a vehicle operator via the user interface 253 or from an ADAS controller during an ADAS operation, such as LCC, adaptive cruise control, or the like. The processor 220 is then operative to receive a map data from the memory 250, location data from the GPS 245 and is operative to calculate a navigational route for the host vehicle to execute the lane change operation from a current lane to a destination lane. In an exemplary embodiment, the navigational route may be a vehicle trajectory for performing the lane change. In an alternate embodiment, the navigational route may include a start point in the original lane, an ending point in the destination lane and may further include one or more waypoints between the starting point and the ending point to better control the vehicle route and vehicle dynamics. In addition, the processor 220 is operative to calculate a PLA based on the upcoming road characteristics. The processor 220 is then operative to compare the PLA to a lateral acceleration threshold. If the PLA does not exceed the lateral acceleration threshold, the processor 220 is then operative to generate control signals to perform the lane change operation. If the PLA does exceed the lateral acceleration threshold, the processor 220 may deny the lane change operation and provide an alert to the vehicle operator indicating the denial of the lane change.

In an alternative embodiment, if the PLA exceeds a lateral acceleration threshold, the processor 220 may be operative to recalculate a navigational path to execute the lane change. The recalculated lane change may include a reduced host vehicle speed during the lane change. The processor 220 may be operative to detect a curve in the upcoming roadway characteristics, wherein portions of the curve result in a PLA exceeding the threshold. The processor 220 may then be operative to recalculate the navigational route such that the lane change is executed before or after the portions of the curve resulting in the PLA exceeding the threshold. The disclosed methods and apparatus may be used with any number of different systems and is not specifically limited to the operating environment shown here. The architecture, construction, setup, and operation of the system and its individual components is generally known. Other systems not shown here could employ the disclosed methods as well.

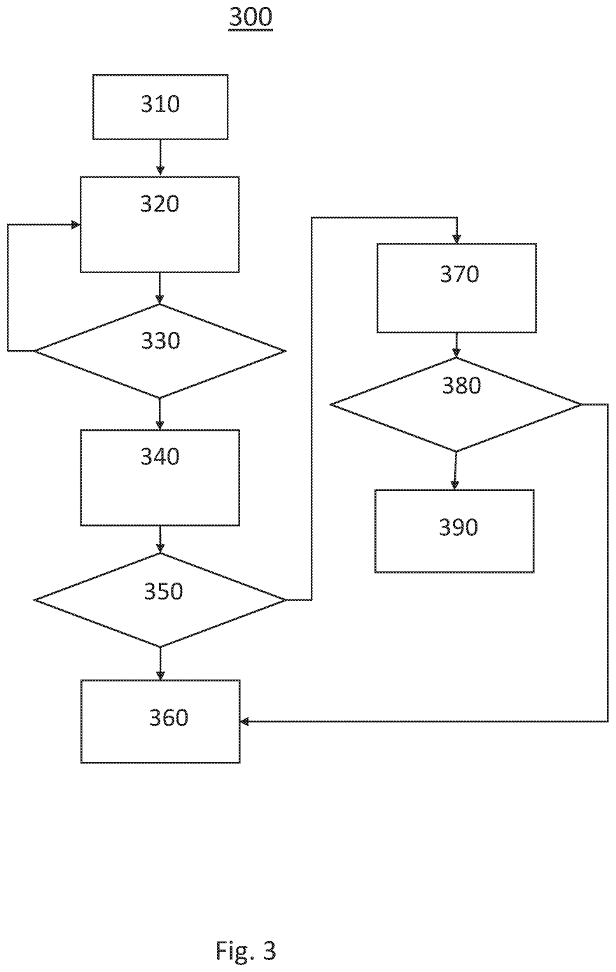

Turning now to FIG. 3, a flow chart illustrating an exemplary implementation of a method 300 for predictive lateral acceleration for a lane change on demand operation in an ADAS equipped motor vehicle is shown. The method is first operative to engage 310 an ADAS algorithm. The ADAS operation may be an adaptive cruise control operation, a lane centering operation or the like. The ADAS may be engaged in response to a user input via a user interface or may be initiated by a vehicle controller in response to another ADAS operation. In response to the engagement of the ADAS operation, the method is next operative to perform 320 the ADAS operation. The ADAS controller may be operative to collect data to determine the location of proximate vehicles and to receive map data related to the current roadway, such as number of lanes, entrances and exits, speed limits, traffic indicators and the like. The ADAS may use this data to generate an object map to track the locations of objects proximate to the host vehicle. During performance of the ADAS operation, such as a LCC operation, the DMS may be operative to monitor the driver engagement. The ADAS may be operative to provide a driver warning and/or disengage the ADAS operation in response to a determination that the is an insufficient level of driver engagement.

The method is next operative to determine 330 if a lane change request has been received. The lane change request may be initiated by a vehicle operator request, such as activation of a turn signal or voice command or may be initiated by a an ADAS controller in response to a determination by an assisted driving algorithm. In an exemplary embodiment, the lane change request may be generated by a vehicle operator activating a turn signal switch during the ADAS operation. For example, the vehicle operator may active a left turn signal during an LCC operation indicating that the operator may wish to perform a lane change operation to the next leftward lane. If a lane change request has not been received, the method is operative to continue to perform 320 the ADAS.

If a lane change request has been received, the method is next operative to calculate 340 a lane change navigational route. The lane change navigational route may be calculated in response to map data, sensor data and vehicle sensor data, such as vehicle velocity. The lane change navigational route may start in the current land and ends in the destination lane with one or more intermediate points established to ensure a smooth lane change with minimal changes in lateral acceleration in order to maintain passenger comfort and vehicle stability. In one exemplary embodiment, the method may perform a longitudinal lane change planning algorithm to generate a longitudinal navigational route and a lateral lane change planning algorithm to generate a lateral navigational route.

The method is next operative to determine 350 if there is a curve during the calculated lane change navigational route. If there is no significant curve detected along the lane change navigational route, the method is operative to perform the lane change operation. The lane change operation may be performed by generating control signals representative of the lane change navigational route to a vehicle controller or the like such that the host vehicle follows the lane change navigational route. In addition, the lane change navigational route may be updated during the lane change operation in response to host vehicle sensor data, vehicle to vehicle communications, or other data sources. In an exemplary embodiment, the longitudinal navigational route may then be executed in response to a longitudinal velocity controller and the lateral navigational route may then be executed in response to a lateral velocity controller.

If there is a curve detected the lane change navigational route, the method is operative to calculate 370 a PLA at periodic points along the lane change navigational route. In an exemplary embodiment, the PLA 340 of the roadway may be calculated using control curve, expected bank angle, vehicle speed and vehicle acceleration. The PLA may be determined in response to the sum of the centripetal acceleration and the tangential acceleration, where v is the vehicle velocity, r is the radius of the curve, g is gravitational acceleration and ø is the road bank angle.

$$PLA = \frac{{v}^{2}}{r} + g * sin ( ∅ )$$

The method is next operative to compare 380 the calculated PLAs to a lateral acceleration threshold. The lateral acceleration threshold may be a predetermined lateral acceleration threshold at which vehicle movement may be uncomfortable to a vehicle occupant or may be detrimental to vehicle performance and stability. If the calculated PLAs exceed the threshold, the method may then be operative to deny 390 the lane change operation and not perform the lane change maneuver. In addition, the method may be operative to provide a warning or alert to a vehicle operator indicative of the denial of the lane change operation.

In an alternative, the method may be operative to delay execution of the lane change operation if the calculated PLAs exceed the lateral acceleration threshold. For example, the method may be operative to slow the vehicle during the curve within the current lane until the curve has been traversed, recalculate additional PLAs for the upcoming roadway after the curve, and execute the lane change operation if the additional PLAs do not exceed the lateral acceleration threshold.

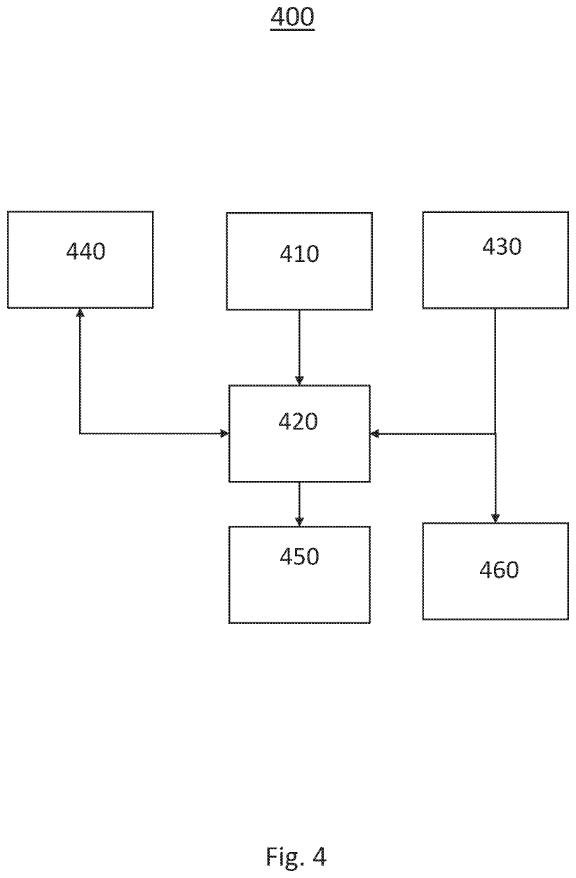

Turning now to FIG. 4, a block diagram illustrating another exemplary implementation of a system 400 for predictive lateral acceleration for a lane change on demand operation in an ADAS equipped motor vehicle is shown. The exemplary system 400 may include a global positioning sensor 410, a processor 420 an input device (e.g., a user interface, touch screen, switch, knob, and/or other user interface) 430 a memory 440, a vehicle controller 450, and a display 460

In the exemplary system 400, the input device (e.g., user interface) 430 is configured for receiving a lane change request. The input device 430 may receive a user input, wherein a user may generate the lane change request, or may be a coupling to an ADAS processor or the like for performing an ADAS algorithm, such as LCC or adaptive cruise control. On one exemplary embodiment, the input 430 may be a turn signal indicator and may be actuated by a vehicle operator. The exemplary system may further include a global positioning sensor 410 for determining a vehicle location in response to a plurality of satellite signals. The system may further include a memory 440 for storing a map data. The map data may be received via a wireless network connection, such as a cellular data network. The map data may be high definition map data including location of traffic lanes, traffic signs, traffic lights, position, and height of the curbs. High definition maps may have a spatial resolution of 10 cm or less making the map data useful for vehicle localization purposes.

The exemplary system 400 may include a processor 420, such as microcontroller, digital signal processor, hardware based discrete processor configured for generating the lane change navigational route in response to the map data and the lane change request, for calculating a predicted lateral acceleration within the lane change navigational route in response to the map data and the lane change request and for coupling the lane change navigational route to the vehicle controller 450 in response to the predicted lateral acceleration being less than a lateral acceleration threshold. The processor 420 may further be operative to deny the lane change request and to generate an operator notification in response to the predicted lateral acceleration exceeding the lateral acceleration threshold. In one exemplary embodiment, the predicted lateral acceleration may be calculated in response to a curve within the lane change navigational route.

In one exemplary embodiment, the processor 420 may be further operative to detect a roadway curve in response to the lane change navigation route and to calculate a plurality of predicted lateral accelerations at a plurality of points within the curve. The processor 420 may be further operative to delay the lane change request in response to the predicted lateral acceleration exceeding the lateral acceleration threshold and to recalculate the predicted lateral acceleration at a point beyond the lane change navigational route. The processor 420 may be further operative to generate an alternate lane change navigational route at a reduced vehicle speed in response to the predicted lateral acceleration exceeding the lateral acceleration threshold. The processor 420 may also be operative generate a throttle control signal indicative of a reduced host vehicle speed to couple to the vehicle controller 450 in response to the predicted lateral acceleration exceeding the lateral acceleration threshold. The system 400 may further include a vehicle controller 450 for performing a lane change in response to a lane change navigational route

In an exemplary embodiment, the exemplary system 400 may be an advanced driver assistance system for controlling a host vehicle an input for receiving a request for a lane change, a processor 420 operative to generate a lane change navigational route in response to a map data, a current vehicle location, and the request for the lane change, the processor 420 being further operative to determine a predicted lateral acceleration at a point along the lane change navigational route, the processor 420 being further operative to generate a warning signal in response to the predicted lateral acceleration exceeding a lateral acceleration threshold, and a display 460 for displaying a denial of lane change to a vehicle operator in response to the warning signal. In a further exemplary embodiment, the advanced driver assistance system for controlling the host vehicle may further include a vehicle controller 450 for controlling a vehicle along the lane change navigational route in response to the lateral acceleration threshold exceeding the predicted lateral acceleration.

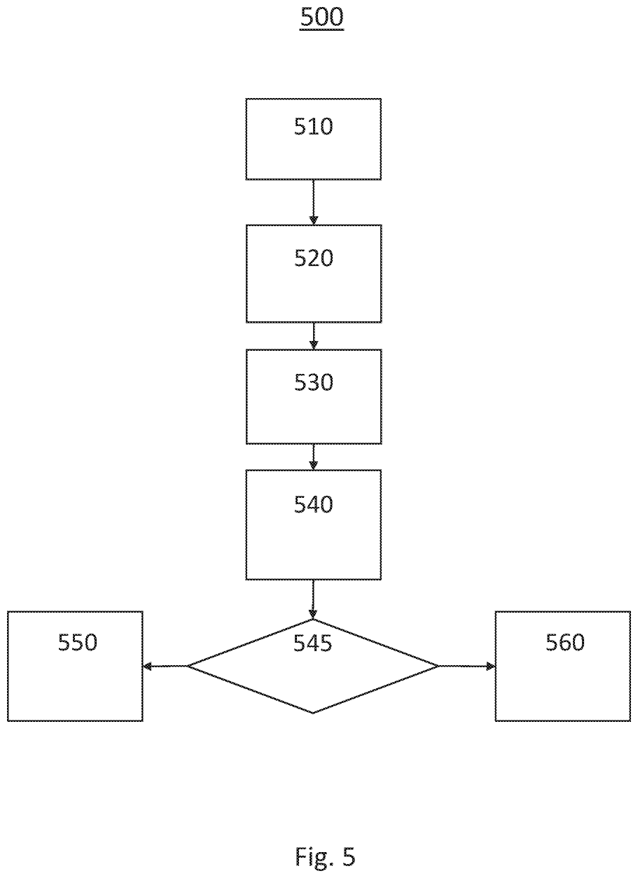

Turning now to FIG. 5, a flow chart illustrating an exemplary implementation of a system 500 for predictive lateral acceleration for a lane change on demand operation in an ADAS equipped motor vehicle is shown. Initially, the method may be configured for performing 510 an advanced driving assistance algorithm, such as a lane centering control algorithm, adaptive cruise control or the like. The method is next operative for receiving 520 a request for a lane change. In an exemplary embodiment, the request for a lane change is received via a user input. Alternatively, the request for a lane change may be received via an advanced driving assistance system controller operative to perform and ADAS algorithm.

The method is next operative for generating 530 a lane change navigational route in response to the request for a lane change, a vehicle location and a map data. The lane change navigational route may be generated in response to a lane change navigational route algorithm and may include a starting point, a destination, and various waypoints along the navigational route. The various waypoints and destination may be chosen, in part, to execute a smooth lane change with a maximum lateral acceleration comfortable to a vehicle occupant and suitable for increased vehicle stability. The maximum lateral acceleration, or the lateral acceleration threshold, may be determined in part in response to a user defined preference, such as slow lane changes with minimal lateral acceleration, or quick lane changes with greater lateral acceleration.

The method is next operative for calculating 540 a PLA for the lane change navigational route. In one exemplary embodiment, the PLA may be a maximum PLA determined in response to calculating a PLA for various points periodically spaced along the lane change navigational route. Alternatively, the PLA may be a mean or average PLA over a interval of the lane change navigational route. The method is then operative to compare 545 the PLA to a lateral acceleration threshold. If the PLA does not exceed the lateral acceleration threshold, the method is then operative for executing 550 a lane change in response to the lane change navigational route.

If the PLA does exceed the lateral acceleration threshold, the method may be operative for generating 560 an indication of a denial of the request for a lane change in response to the predicted lateral acceleration exceeding the lateral acceleration threshold. In one exemplary embodiment, the predicted lateral acceleration may be calculated in response to a curve within the lane change navigational route. Alternatively, the method may be further operative for detecting a curve in a roadway in response to the lane change navigational route and wherein the predicted lateral acceleration is calculated for a plurality of points within the curve in the roadway. The method may be operative to delay the execution of the lane change in response to the predicted lateral acceleration exceeding the lateral acceleration threshold. Alternatively, the method may be operative for generating an alternate lane change navigational route at a reduced vehicle speed in response to the predicted lateral acceleration exceeding the lateral acceleration threshold. The method may be operative to reduce a vehicle speed in response to the predicted lateral acceleration exceeding the lateral acceleration threshold.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A vehicle comprising:
an input device for receiving a lane change request;
a global positioning sensor for detecting a vehicle location;
a memory for storing a map data;
a vehicle controller for performing a lane change in response to a lane change navigational route; and
a processor configured for generating the lane change navigational route in response to the map data and the lane change request, for calculating a predicted lateral acceleration within the lane change navigational route in response to the map data and the lane change request and for coupling the lane change navigational route to the vehicle controller in response to the predicted lateral acceleration being less than a lateral acceleration threshold.

2. The vehicle of claim 1 wherein the processor is further operative to deny the lane change request and to generate an operator notification in response to the predicted lateral acceleration exceeding the lateral acceleration threshold.

3. The vehicle of claim 1 wherein the predicted lateral acceleration is calculated in response to a curve within the lane change navigational route.

4. The vehicle of claim 1 wherein the processor is further operative to detect a roadway curve in response to the lane change navigation route and to calculate a plurality of predicted lateral accelerations at a plurality of points within the curve.

5. The vehicle of claim 1 wherein the processor is further operative to delay the lane change request in response to the predicted lateral acceleration exceeding the lateral acceleration threshold and to recalculate the predicted lateral acceleration at a point beyond the lane change navigational route.

6. The vehicle of claim 1 wherein the processor is operative to generate an alternate lane change navigational route at a reduced vehicle speed in response to the predicted lateral acceleration exceeding the lateral acceleration threshold.

7. The vehicle of claim 1 wherein the processor is further operative to generate a throttle control signal indicative of a reduced host vehicle speed to couple to the vehicle controller in response to the predicted lateral acceleration exceeding the lateral acceleration threshold.

8. The vehicle of claim 1 wherein the lane change request is generated in response to a user input.

9. A method performed by a processor comprising:
performing an advanced driving assistance algorithm;
receiving a request for a lane change;
generating a lane change navigational route in response to the request for a lane change, a vehicle location and a map data;
calculating a predicted lateral acceleration in response to the navigational route; and
executing a lane change in response to the lane change navigational route in response to the predicted lateral acceleration being less than a lateral acceleration threshold.

10. The method of claim 9 further including generating an indication of a denial of the request for a lane change in response to the predicted lateral acceleration exceeding the lateral acceleration threshold.

11. The method of claim 9 wherein the predicted lateral acceleration is calculated in response to a curve within the lane change navigational route.

12. The method of claim 9 further including detecting a curve in a roadway in response to the lane change navigational route and wherein the predicted lateral acceleration is calculated for a plurality of points within the curve in the roadway.

13. The method of claim 9 further including delaying the execution of the lane change in response to the predicted lateral acceleration exceeding the lateral acceleration threshold.

14. The method of claim 9 further including generating an alternate lane change navigational route at a reduced vehicle speed in response to the predicted lateral acceleration exceeding the lateral acceleration threshold.

15. The method of claim 9 further including reducing a vehicle speed in response to the predicted lateral acceleration exceeding the lateral acceleration threshold.

16. The method of claim 9 wherein the predicted lateral acceleration is generated in response to a lane change request received via an ADAS algorithm.

17. The method of claim 9 wherein the request for a lane change is received via a user input.

18. The method of claim 9 wherein request for a lane change is received via an advanced driving assistance system controller.

19. An advanced driver assistance system for controlling a vehicle comprising:
an input for receiving a request for a lane change;
a processor operative to generate a lane change navigational route in response to map data, a current vehicle location, and the request for the lane change, the processor being further operative to determine a predicted lateral acceleration at a point along the lane change navigational route, the processor being further operative to generate a warning signal in response to the predicted lateral acceleration exceeding a lateral acceleration threshold; and
a display for displaying a denial of lane change to a vehicle operator in response to the warning signal.

20. The advanced driver assistance system for controlling the host vehicle of claim 19 further including a vehicle controller for controlling a vehicle along the lane change navigational route in response to the lateral acceleration threshold exceeding the predicted lateral acceleration.
